(19) United States
(12) Patent Application Publication
(10) Pub. No.: US 2008/0072199 A1
(43) Pub. Date: Mar. 20, 2008

(54) Method for designing semiconductor integrated circuit

(76) Inventors: Kyoji Yamashita, Kyoto (JP); Daisaku Ikoma, Osaka (JP); Shinji Watanabe, Osaka (JP); Katsuhiro Ootani, Nara (JP)

Correspondence Address: MCDERMOTT WILL & EMERY LLP, 600 13TH STREET, NW, WASHINGTON, DC, 20005-3096, US

(21) Appl. No.: 11/709,749

(22) Filed: Feb. 23, 2007

(30) Foreign Application Priority Data
Jun. 14, 2006 (JP) 2006-164473

(51) Int. Cl. G06F 17/50

(52) U.S. Cl. 716/6

(57) ABSTRACT

The effective distance Deff_i between a well boundary and an active region of a transistor is used as a parameter for expressing a well proximity effect. For example, a delay library is created using the rising time Tslew of a signal input to the gate, load capacitance Cload at the output side and Deff_i. The use of the effective distance Deff_i between the well boundary and the transistor allows very simple modeling to be accurately performed, so that a gate-level simulation considering a well proximity effect at an LSI level is enabled.

### BACKGROUND OF THE INVENTION

(1) Field of the Invention

The present invention relates to a method for designing a semiconductor integrated circuit in which a large number of MIS transistors are integrated.

(2) Background Art

In recent years, in the field of large scale integration (LSI) such as MIS semiconductor integrated circuits, design specifications required of integrated circuits have been diversified and become complicated with miniaturization of semiconductor-device patterns, enhancement of integration degree and increase of operation speed of semiconductor devices. With enhancement of performance and integration degree of LSI, it has become very important to accurately calculate a delay time in order to determine LSI performance.

LSI is generally formed by combining a large number of basic function unit circuits called cells. The delay time of LSI is determined by the driving ability of MIS transistors forming cells, the parasitic capacitance and parasitic resistance of transistors in the cells, and the parasitic capacitance and parasitic resistance of lines connecting the cells. A computer aided design (CAD) tool plays a very important role in accurately designing an LSI circuit. The delay time in a cell is estimated by a circuit simulation that takes a long time for calculation but has high accuracy. The delay time of the entire LSI circuit is estimated by a gate-level simulation that has accuracy lower than the circuit simulation but is performed at high speed. If the delay time of the entire LSI circuit is calculated by the circuit simulation, an enormous amount of calculation is needed. Therefore, the gate-level simulation is used to reduce the time necessary for design.

In the gate-level simulation, the delay of LSI at a block level (where the number of cells is several thousands to several hundreds of thousands) is accurately simulated at high speed using a delay library and a net list. The delay library is obtained by previously performing a circuit simulation on designed cells using delay information on combinations of the slopes of waveforms of various types of input signals and load capacitance at the output side. The net list is obtained by extracting parasitic capacitance and parasitic resistance of lines connecting cells from a mask layout at a block level of an LSI circuit using a layout parameter extraction (LPE) device of the circuit.

FIG. 9 is a view for explaining a delay library in a gate-level simulation. In FIG. 9, it is assumed that a gate 200 and a load capacitance Cload 203 connected to the output of the gate 200 are provided. The gate 200 is, for example, an inverter. In this case, suppose the rising time of a signal input to the gate is Tslew, the delay time Tpd is a function of Tslew and Cload.

Advanced miniaturization involves new problems in which ideal single transistors used for extracting a model parameter and CMOS transistors in cells used in actual design have a large difference in characteristics. One of the problems is a transistor characteristic variation caused by a well proximity effect.

FIGS. 10A through 10D are views for explaining a transistor characteristic variation caused by a well proximity effect. FIG. 10A is a cross-sectional view for explaining the well proximity effect. FIG. 10B is a plan mask view for explaining the well proximity effect. FIG. 10C is a graph showing the amount of change of the impurity concentration of phosphorus (P) in an n-well 105. FIG. 10D is a graph showing the amount of change of Vth increased by the well proximity effect. In FIG. 10B, OD denotes an active region, SCY denotes the distance from the active region to a well boundary 106, GA denotes a mask for forming a gate electrode and W denotes the gate width.

As illustrated in FIG. 10A, in forming an n-well 105 in a semiconductor substrate in which a p-well 101 is formed, ion implantation 103 of an n-type impurity such as phosphorus (P) is performed with high energy with a resist mask 102 formed on the p-well 101. At this time, part of the n-type impurity ions is scattered in the resist mask 102, so that redundant n-type impurity ions 104 are implanted in the n-well 105. As a result, the threshold value Vth of a transistor formed on the n-well 105 increases. As shown in FIG. 10D, the amount of this Vth increase becomes lager as the distance from the well boundary 106 to the transistor decreases. This phenomenon causes a transistor characteristic variation by a well proximity effect.

A representative example of a document explaining a well proximity effect is C. Hu, et al., BSIM4.5.0 model Enhancements, p. 8, 2005.

### SUMMARY OF THE INVENTION

The technique described in C. Hu, et al., BSIM4.5.0 model Enhancements, p. 8, 2005, however, is for a circuit simulation and, though a well proximity effect is reflected at a cell level, a gate-level simulation considering a well proximity effect at a block level cannot be performed. Now, this will be more specifically described.

FIG. 11 is a plan view for explaining drawbacks in a conventional technique. In FIG. 11, OD denotes an active region, GA denotes a mask for forming a gate electrode, PW denotes a p-well, NW denotes an n-well, reference numerals 151, 152, 153, 154 and 155 enclosed by dotted lines denote first, second, third, fourth and fifth cells, and NMOS1 denotes an n-MOS transistor in the fourth cell 154. In FIG. 11, a portion of a cell block of LSI is illustrated and arrows indicate that the n-well extends to a region which is not shown.

For example, in FIG. 11, if only the inside of the fourth cell 154 is taken into consideration, only the well boundary in one direction (i.e., a well boundary 106a) is present with respect to the NMOS1. However, in the entire configuration illustrated in FIG. 11, i.e., at a block level of LSI, well boundaries 106b and 106c are also present between the first cell 151 and the fourth cell 154 and between the second cell 152 and the fourth cell 154, respectively. In this case, the NMOS1 is surrounded by the well boundaries in three directions, so that the amount of redundant implanted impurity ions generated by scattering is large and the amount of Vth increase is large, as compared to the case of one direction. However, in a conventional gate-level simulation, no models and parameters for considering a well proximity effect at a block level are provided.

It is therefore an object of the present invention to provide a method for designing a semiconductor integrated circuit provided with a gate-level simulation enabling a simulation in which a well proximity effect is taken into consideration at least at a block level.

A method for designing a semiconductor integrated circuit according to the present invention is a method for fabricating a semiconductor integrated circuit including: a substrate in which a well boundary is formed; and a transistor having a gate on an active region in the substrate. The method includes the step of performing a gate-level simulation using a distance between the well boundary and the active region as a parameter.

This method enables a gate-level simulation for accurately estimating a transistor characteristic variation by a well proximity effect. Accordingly, errors of a simulation at an LSI level or a block level are reduced, so that the design period is shortened and increase in development cost is prevented.

If a plurality of well boundaries are provided in the substrate in different directions with respect to the transistor, in the step of performing a gate-level simulation, a simple sum of influences of these well boundaries obtained by using, as parameters, distances from the respective well boundaries to the active region is approximated as an influence of the well boundaries on the transistor. This allows the influence of a plurality of well boundaries on the transistor to be easily calculated.

### BRIEF DESCRIPTION OF THE DRAWINGS

FIG. 1 is a plan view for explaining a delay library at a gate level in consideration of a well proximity effect.

FIG. 2 is a plan view for explaining a parameter provided to consider a well proximity effect in the delay library at the gate level.

FIG. 3 is a flow chart regarding parameter extraction and verification of the parameter for having a gate-level simulation reflect a well proximity effect.

FIGS. 4A and 4B are layouts showing patterns used for parameter extraction in a one-direction model of a well proximity effect.

FIGS. 5A and 5B are graphs showing an example of results of well proximity effect modeling in one direction.

FIG. 6 is a view illustrating model extension of a well proximity effect in four directions.

FIG. 7 is a view illustrating a verification pattern of well proximity effect modeling in four directions.

FIGS. 8A and 8B are graphs showing an example of results of well proximity effect modeling in four directions.

FIG. 9 is a view for explaining a delay library in a gate-level simulation.

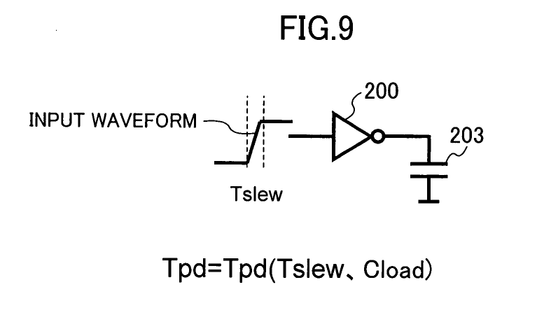

FIGS. 10A and 10D are views and graphs for explaining transistor characteristic variation caused by a well proximity effect.

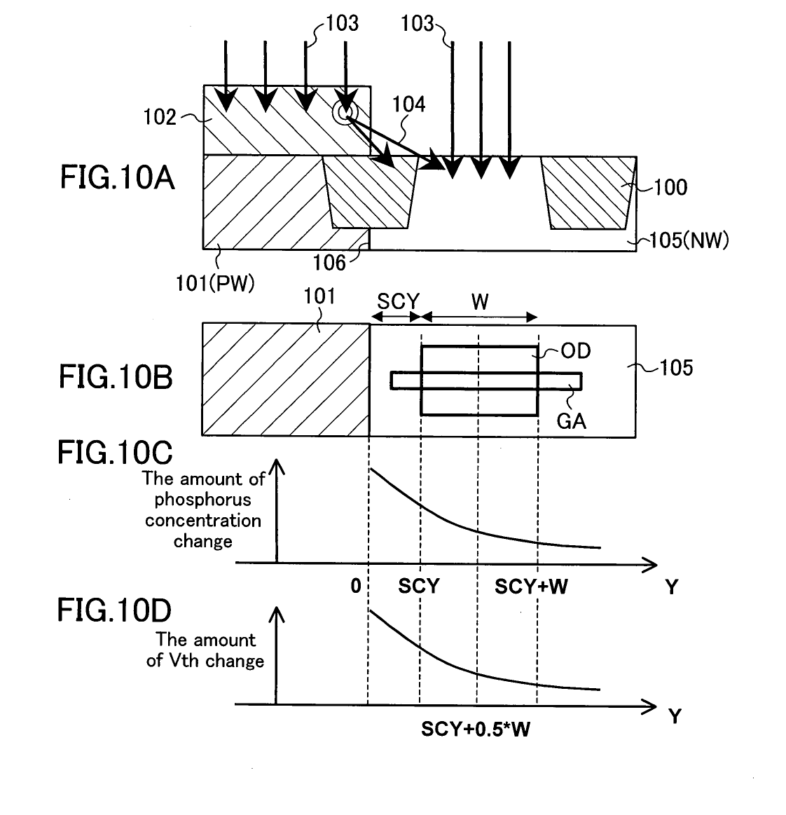

FIG. 11 is a plan view for explaining problems in a conventional technique.

### DETAILED DESCRIPTION OF THE INVENTION EMBODIMENT

An embodiment of the present invention will be described with reference to the drawings.

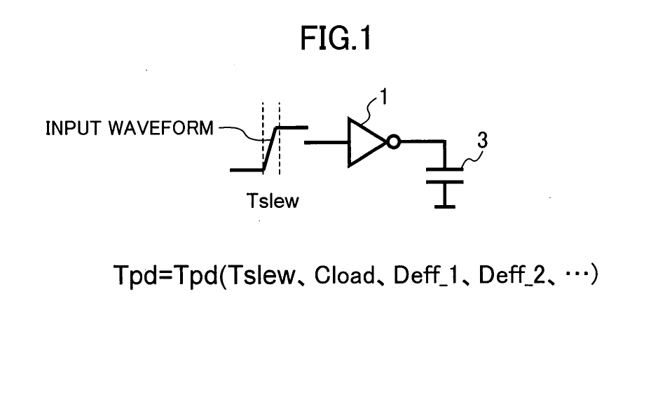

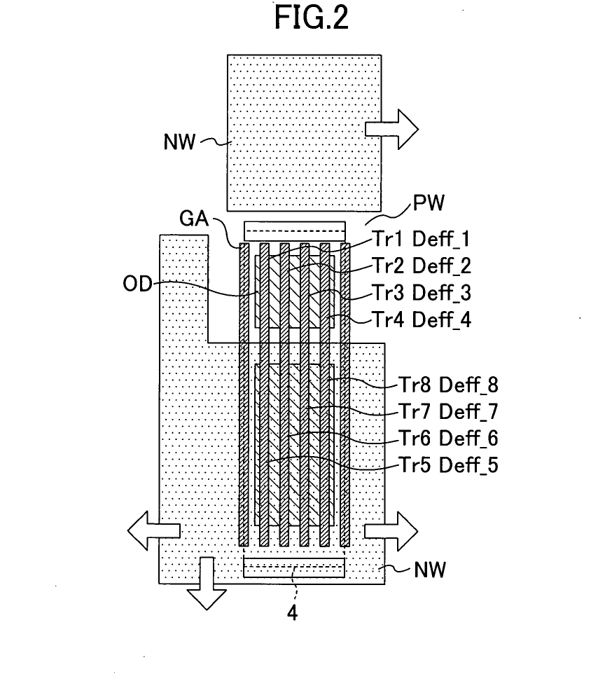

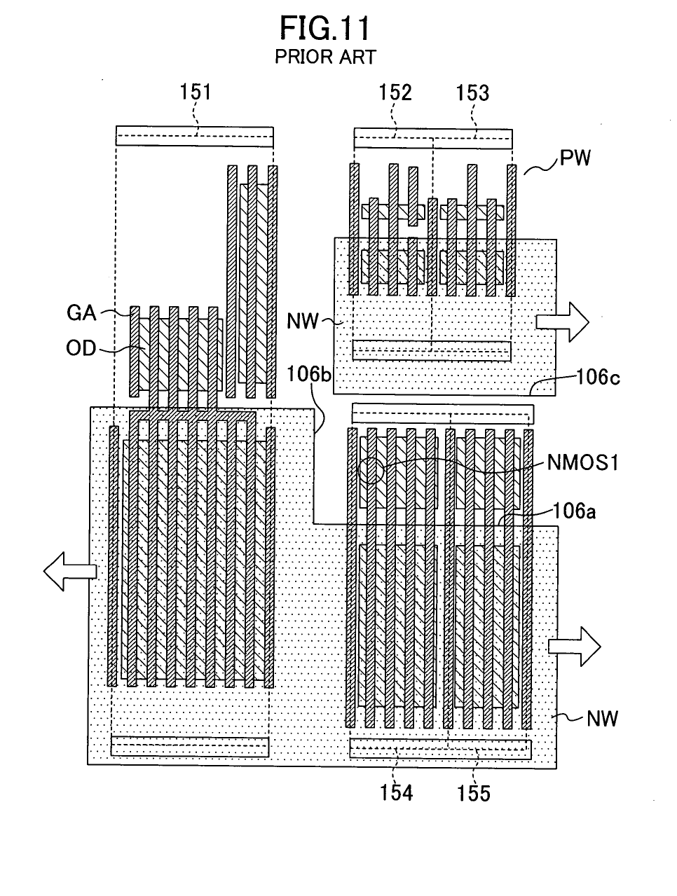

FIG. 1 is a plan view for explaining a delay library at a gate level in which a well proximity effect is taken into consideration. FIG. 2 is a plan view for explaining a parameter provided to consider a well proximity effect in the delay library at the gate level. In FIG. 1, it is assumed that a gate (logic gate) 1 and a load capacitance (Cload) 3 connected to the output of the gate 1 are provided. The gate 1 is, for example, an inverter and a delay library for another logic gate is also created in actual application. FIG. 2 shows a cell (referred to as a cell 4) identical to the fourth cell 154 in the cell block illustrated in FIG. 11 and well boundaries near the cell. In FIG. 2, OD denotes an active region, GA denotes a mask for forming a gate electrode, PW denotes a p-well and NW denotes an n-well. The active region OD is a region of a semiconductor substrate surrounded by an isolation region.

In the cell 4 illustrated in FIG. 2, n-transistors Tr1, Tr2, Tr3 and Tr4 and p-transistors Tr5, Tr6, Tr7 and Tr8, for example, are provided.

In this case, suppose the rising time of a signal input to the gate is Tslew, the delay time Tpd is expressed as a function of Tslew, Cload and Deff_i. In this case, Deff_i is a parameter of a well proximity effect indicating the effective distance between a well boundary and a transistor and the number of Deff_i corresponds to the number of transistors. In the example illustrated in FIG. 2, Deff_i (i=1 to 8) is one of Deff_1, Deff_2, . . . and Deff_8 which are effective distances between well boundaries and transistors.

The simulation method of this embodiment is characterized by using Deff_i as a parameter of a well proximity effect in creating a delay library at a gate level. Deff_i can also be used as a parameter of a well proximity effect in calculating transistor electrical characteristics such as a threshold value (Vth) and saturation drain current (Idsat) in a circuit simulation such as SPICE. The obtained delay library, for example, is stored in a storage device or other devices so that the library is easily used by a simulator or a computer. Using such a delay library and a function expression indicating electrical characteristics of transistors, a gate-level simulation is performed on a delay time, for example. This gate-level simulation is performed by a simulator having the function of receiving Deff_i.

In the method for designing a semiconductor integrated circuit of this embodiment, parameters such as Deff_i and the gate width and the gate length of transistors are extracted from circuit connection information stored in, for example, a CAD tool using a layout parameter extraction (LPE) device so that a net list is created. Thereafter, a gate-level simulation is performed by a simulator using this net list and the delay library obtained in the manner described above. In this manner, parameters in which a well proximity effect is taken into consideration are extracted and used, thus allowing a gate-level simulation to be performed with higher accuracy than conventional techniques.

In particular, in the design method of this embodiment, parameters are set in consideration of influences of not only a well boundary in one direction but also well boundaries in four directions, i.e., up, down, left and right, on transistor characteristics. As described below, the influence of the well boundaries in the four directions on transistor characteristics is approximated by obtaining the simple sum of the influences of the well boundaries on a transistor. The effective distances Deff_i between respective well boundaries and a transistor are the distances from respective well boundaries extending in four directions, i.e., up, down, left and right, with respect to a target transistor to the target transistor in consideration of the influences of the well boundaries. Hereinafter, it will be specifically described how Deff_i is calculated from a layout and is linked to transistor characteristics.

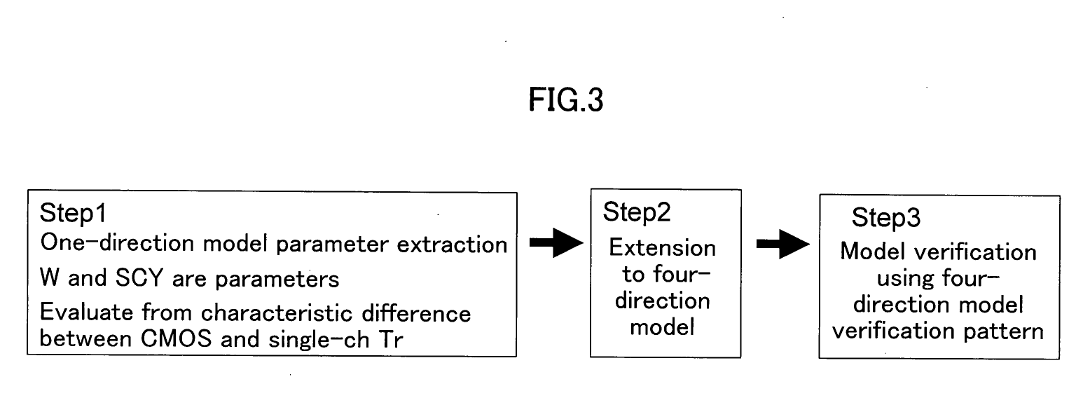

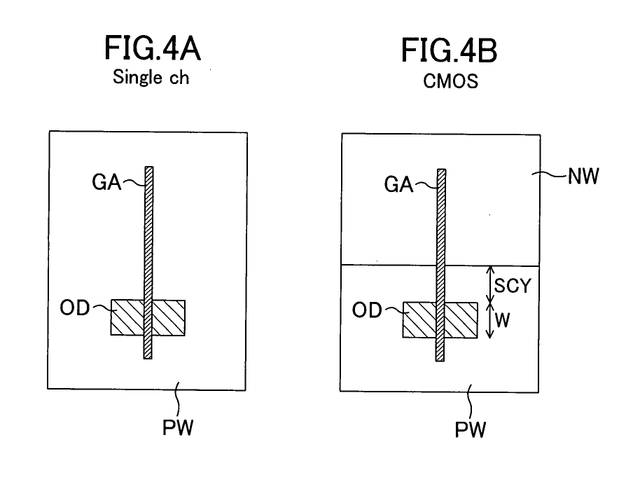

FIG. 3 is a flow chart regarding parameter extraction for having a gate-level simulation reflect a well proximity effect and verification of the extracted parameter. FIGS. 4A and 4B are layouts showing patterns used for parameter extraction for a well proximity effect in a one-direction model.

As shown in FIG. 3, the flow of parameter extraction and verification of the parameter is broadly divided into three steps. First, at step 1, a model parameter for indicating an influence of a well boundary in one direction is extracted. Next, at step 2, the result obtained at step 1 is extended to a four-direction model. Then, at step 3, the model obtained at step 2 is verified using a verification pattern of the four-direction model. Hereinafter, the respective steps will be specifically described.

At step 1, parameter extraction is performed with a one-direction model parameter extraction pattern for a well proximity effect as shown in FIGS. 4A and 4B. FIG. 4A shows an nMOS transistor of a so-called single channel. Each of the well boundaries located on the top, bottom, left and right, respectively, of this MOS transistor is located at a distance equal to or longer than a distance which can be regarded as infinite. FIG. 4B shows an nMOS transistor of CMOS. In FIGS. 4A and 4B, OD denotes an active region, GA denotes a mask for forming a gate electrode, PW denotes a p-well and NW denotes an n-well. The active region OD is a region of a semiconductor substrate surrounded by an isolation region. SCY denotes the distance between a well boundary located above the transistor in the gate width direction and the active region OD of the transistor. W denotes the gate width of the transistor. The transistor of a single-channel shown in FIG. 4A is assumed to be free from the influence of a well boundary in any direction. Accordingly, the influence of a well proximity effect is estimated by measuring a characteristic difference between the transistor of CMOS shown in FIG. 4B and the transistor of a single-channel.

The amount ΔVth change of the transistor threshold voltage due to a change of an impurity concentration caused by a well proximity effect is proportional to the square root of the impurity concentration. It is found from experiments that the impurity concentration increase by a well proximity effect is inversely proportional to the distance from a well boundary. Thus, if the effective distance Deff between a transistor and a well boundary is defined as:
Deff=SCY+W/2 (1)
then the following equation (2) is established:
ΔVth=Vth(Deff)−Vth(∞)=A1/√Deff+B1 (2)
where ΔVth is defined with reference to a single transistor whose Deff can be regarded as infinite as shown in FIG. 4A and A1 and B1 are constants.

The saturation current value Idsat of drain current of a transistor changes depending on a change of the impurity concentration caused by a well proximity effect. The amount ΔIdsat of change of the saturation current value Idsat is proportional to the square of the amount ΔVth of change of the threshold voltage, and is expressed by the following equation:
ΔIdsat=[Idsat(Deff)−Idsat(∞)]/Idsat(∞)=A2/Deff+B2 (3)
where ΔIdsat is a rate of change of drain current with reference to Idsat in a single transistor whose Deff can be regarded as infinite and A2 and B2 are constants.

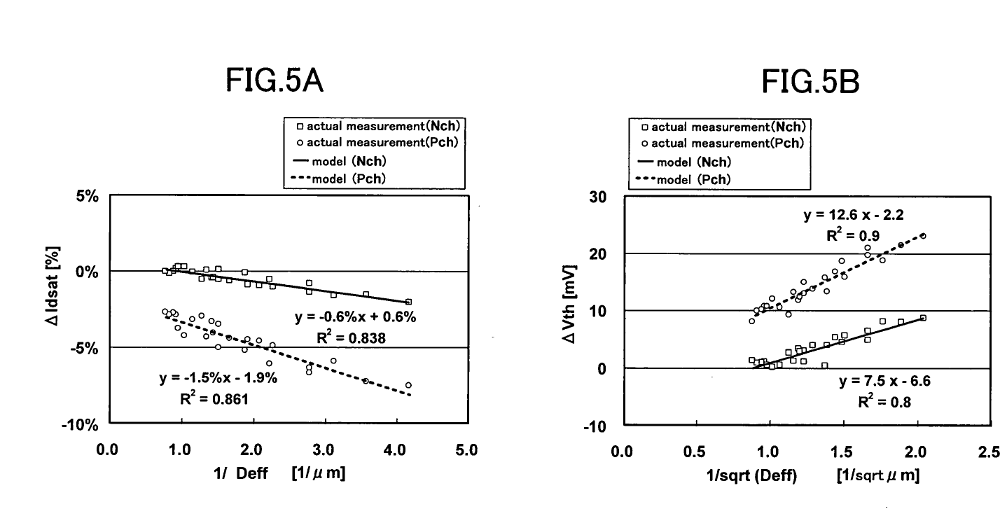

FIGS. 5A and 5B are graphs showing an example of results of modeling of a well proximity effect in one direction. FIG. 5A shows a relationship between ΔIdsat and Deff. FIG. 5B shows a relationship between ΔVth and Deff. In FIGS. 5A and 5B, □ denotes an actually measured value of an nMOS transistor, ∘ denotes an actually measured value of a pMOS transistor and solid lines denote modeling results. As shown in FIG. 5A, as a result of well proximity effect modeling, modeling of dependence of ΔIdsat of the pMOS transistor on 1/Deff is performed with an accuracy of 1.0% in maximum modeling error within the range from −7.5% to −2.7% of ΔIdsat. It is also shown that modeling of dependence of ΔIdsat of the nMOS transistor on 1/Deff is performed with an accuracy of 0.5% in maximum modeling error within the range from −2.1% to −0.3% of ΔIdsat. On the other hand, as shown in FIG. 5B, modeling of dependence of the threshold value change amount ΔVth of a transistor on 1/√Deff is performed with high accuracy for each of the nMOS transistor and the pMOS transistor.

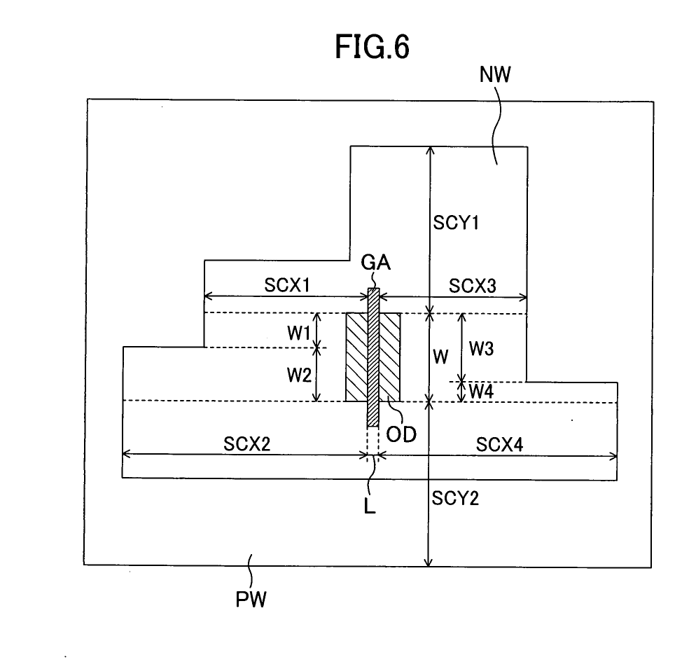

Next, at step 2, model extension is performed in consideration of the influences of well boundaries in four directions with respect to a transistor. FIG. 6 is a view illustrating model extension of a well proximity effect to a four-direction model. In FIG. 6, OD denotes an active region, PW denotes a p-well, NW denotes an n-well, GA denotes a mask for forming a gate electrode, L denotes the gate length of a transistor and W denotes the gate width of the transistor. The active region OD is a region of a semiconductor substrate surrounded by an isolation region. SCX1 through SCX4 denote the distances between respective well boundaries and the transistor in the gate length (L) direction and SCY1 and SCY2 denote the distances between the respective well boundaries and the active region OD of the transistor in the gate width (W) direction. In this case, the effective distance Deff between a well boundary and a transistor is expressed by the following equation (4):
1/Deff=Σ(1/Dxi+1/Dyi) (i=1, 2) (4)
1/√Deff=Σ(1/√Dxi+1/√Dyi) (i=1, 2) (5)
1/Dx1=1/[SCX1*(W1/W)+L/2]+1/[SCX2*(W2/W)+L/2] (6)
1/Dx2=1/[SCX3*(W3/W)+L/2]+1/[SCX4*(W4/W)+L/2] (7)
Dy1=SCY1+W/2 (8)
Dy2=SCY2+W/2 (9)
where it is assumed that Deff and √Deff are expressed by the reciprocal of the sum of the reciprocal of the effective distance Dx in the X direction (i.e., the gate length direction) between a well boundary and the transistor and the reciprocal of the effective distance Dy in the Y direction (i.e., the gate width direction) of a well boundary and the transistor. Dx is calculated with the proportions of the effective distances between the well boundaries and the transistor reflected therein.

Then, at step 3, the four-direction model of a well proximity effect is verified using a model verification pattern. Specifically, with respect to the relationship between ΔIdsat and 1/Deff and the relationship between ΔVth and 1/√Deff, a modeling result and an actually-measured result for a device are compared so that the accuracy in proximity effect modeling is evaluated.

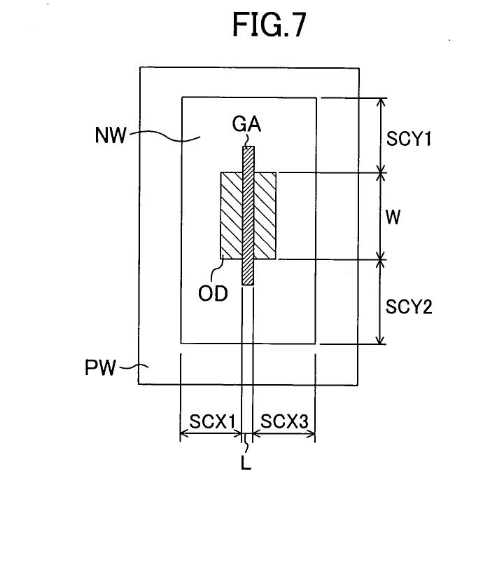

FIG. 7 is a view illustrating a verification pattern of well proximity effect modeling in four directions. In FIG. 7, OD denotes an active region, PW denotes a p-well, NW denotes an n-well, GA denotes a mask for forming a gate electrode, L denotes the gate length of a transistor and W denotes the gate width of the transistor. The active region OD is a region of a semiconductor substrate surrounded by an isolation region. SCX1 and SCX3 denote the distances between respective well boundaries and the active region OD of a transistor in the gate length (L) direction and SCY1 and SCY2 denote the distances between respective well boundaries and the active region OD of the transistor in the gate width (W) direction. FIG. 7 shows a pattern for evaluating a pMOS transistor. In the case of evaluating an nMOS transistor, NW and PW are replaced with each other.

Based on equations (4) through (9), the effective distance Deff between a well boundary and a transistor in this case is expressed by the following equations (10) and (11):
1/Deff=1/Dx1+1/Dx3+1/Dy1+1/Dy2 (10)
1/√Deff=1/√Dx1+1/√/Dx3+1/√Dy1+1/√Dy2 (11)
Dx1=SCX1+L/2 (12)
Dx3=SCX3+L/2 (13)
Dy1=SCY1+W/2 (14)
Dy2=SCY2+W/2 (15)

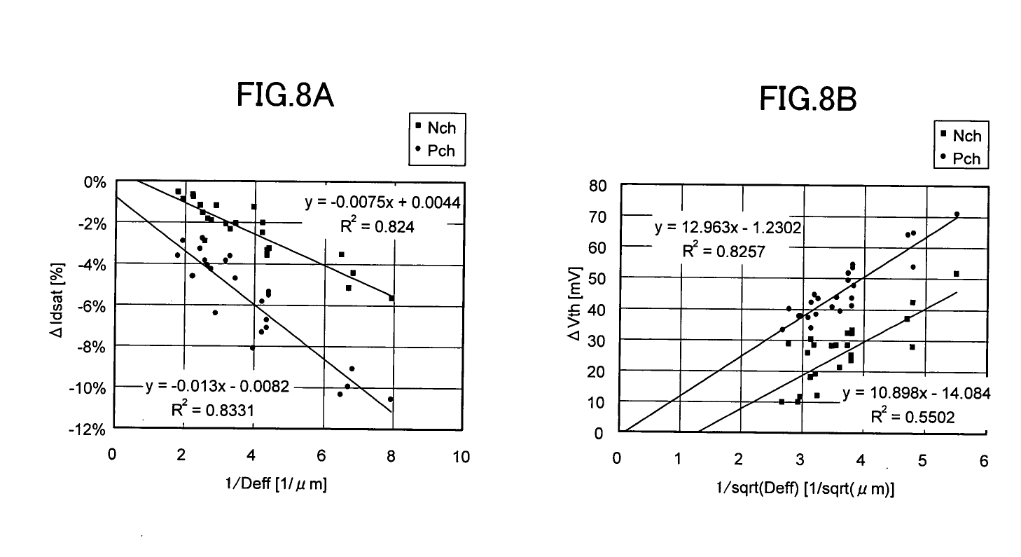

FIGS. 8A and 8B are graphs showing an example of results of well proximity effect modeling in four directions. FIG. 8A shows a relationship between ΔIdsat and Deff in a transistor as shown in FIG. 7. FIG. 8B shows a relationship between ΔVth and √Deff in the same transistor. In FIGS. 8A and 8B, ▪ denotes an actually measured value of an nMOS transistor, ◯ denotes an actually measured value of a p-MOS transistor and solid lines denote modeling results.

In FIGS. 8A and 8B, it is confirmed that the result of well proximity effect modeling in four directions well matches the actually measured values for both ΔIdsat and ΔVth and the well proximity effect modeling in four directions is performed with an accuracy substantially equal to that of the well proximity effect modeling in one direction. This shows that a well proximity effect in the X direction (i.e., the gate length direction) and a well proximity effect in the Y direction (i.e., the gate width direction) have an equal weight. Therefore, in performing well proximity effect modeling in four directions, the influence of the well boundaries in four directions, i.e., up, down, left and right, is substantially approximated by obtaining the simple sum of the influences of the well boundaries. In this manner, in the case where a plurality of well boundaries are provided in different directions with respect to a transistor, if the simple sum of the influences of these well boundaries is obtained, the influence of these well boundaries on the transistor is approximated.

As described above, with the method of this embodiment, the effective distance (Deff) between a well boundary and a transistor is introduced as a model parameter of a well proximity effect so that transistor characteristics are accurately estimated. If this method is applied to a gate-level simulation, a simulation at a block level or an LSI level is accurately performed with little decrease of the calculation speed. Accordingly, with the design method of this embodiment, simulation errors at an LSI level or a block level are reduced, the design period is shortened, and increase in development cost caused by design change is prevented.

The foregoing method is applicable not only to a gate-level simulation but also a hierarchical simulation using SPICE. In this case, a net list is created by parameter extraction using LPE at a cell level based on connection information on a circuit. As a net list at a higher-order block level, it is sufficient to use a net list which has been previously obtained at a cell level.

In equation (1), the effective distance between a transistor and a well boundary is obtained with reference to the center of the active region (OD) of the transistor in the gate width direction, as an example. Alternatively, the distance from an arbitrary portion of the transistor to a well boundary may be used. Likewise, for well proximity effect modeling in four directions, it is unnecessary to use the center of the transistor in the gate length direction in setting Dx1 and Dx3 and the center of the transistor in the gate width direction is not necessarily used as a reference in setting Dy1 and Dy2.

As described above, a simulation method according to the present invention is widely applicable to design of semiconductor integrated circuits.

What is claimed is:

1. A method for designing a semiconductor integrated circuit including: a substrate in which a well boundary is formed; and a transistor having a gate on an active region in the substrate, the method comprising the step of performing a gate-level simulation using a distance between the well boundary and the active region as a parameter.

2. The method of claim 1, wherein the step of performing a gate-level simulation includes the step of creating a delay library using a rising time of a signal input to the gate, a load capacitance at an output side of the gate and the distance between the well boundary and the active region.

3. The method of claim 1, wherein in the step of performing a gate-level simulation, the well boundary extends at least in one direction with respect to the active region and modeling using a distance between the well boundary and the active region is performed.

4. The method of claim 3, wherein a plurality of well boundaries are provided in the substrate in different directions with respect to the active region, and
the step of performing a gate-level simulation includes:
the step of calculating influences of the well boundaries using, as parameters, distances from the respective well boundaries to the active region; and
the step of approximating a simple sum of the influences of the well boundaries as an influence of the well boundaries on the active region.

5. The method of claim 1, wherein the distance between the well boundary and the active region is obtained with reference to a center of the active region.

6. The method of claim 1, wherein in the step of performing a gate-level simulation, a rate of change of a saturation drain current value of the transistor is used as a parameter, and
the rate of change of the saturation drain current value of the transistor has a correlation with the distance between the well boundary and the active region.

7. The method of claim 1, wherein in the step of performing a gate-level simulation, a rate of change of a threshold voltage of the transistor is used as a parameter, and
the rate of change of the threshold voltage of the transistor has a correlation with the distance between the well boundary and the active region.

8. The method of claim 1, further comprising the step of extracting the distance between the well boundary and the active region from connection information on the semiconductor integrated circuit using a circuit extraction device to create a net list, before the step of performing a gate-level simulation,
wherein the gate-level simulation is performed using the net list.
